(19) United States
(12) Patent Application Publication
(10) Pub. No.: US 2024/0155964 A1
(43) Pub. Date: May 16, 2024

(54) EXPECTED PLANTING QUALITY INDICATOR AND MAPPING

(71) Applicant: Kinze Manufacturing, Inc., Williamsburg, IA (US)

(72) Inventors: Jordan J. White, Williamsburg, IA (US); Jason Schoon, Williamsburg, IA (US); Ryan McMahan, Williamsburg, IA (US)

(21) Appl. No.: 18/509,957

(22) Filed: Nov. 15, 2023

Related U.S. Application Data
(60) Provisional application No. 63/383,972, filed on Nov. 16, 2022.

(51) Int. Cl. A01B 79/00

(52) U.S. Cl. CPC A01B 79/005

(57) ABSTRACT

Agricultural implements include numerous electrical components. The settings and other controls for the components can be preset or can be controlled remotely, such as in a display in a tractor, tow vehicle, or other remote location. The settings can be configured to provide the best possible conditions for planting seed or applying particulate to a field in an efficient manner. This may be based on agronomic data, weather conditions, and other considerations. The display may provide additional feedback for the settings, such as expected planting quality. This feedback indicator is dependent upon factors such as the settings, ambient conditions, any issues with the equipment, and the like. This information can be used during planting or after to better instruct the user on planting performance of the implement.

### CROSS REFERENCE TO RELATED APPLICATIONS

This application claims priority under 35 U.S.C. § 119 to provisional patent application U.S. Ser. No. 63/383,972, filed Nov. 16, 2022. The provisional patent application is herein incorporated by reference in its entirety, including without limitation, the specification, claims, and abstract, as well as any figures, tables, appendices, or drawings thereof.

### TECHNICAL FIELD

The present disclosure relates generally to a computer display or other computer readable medium for use in the agricultural industry. More particularly, but not exclusively, the disclosure relates to utilizing ambient conditions and planter settings to adjust expectations on how well aspects of an agricultural implement will operate.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Agricultural implements perform a variety of agricultural operations. For example, an agricultural row crop planter is a machine built for precisely distributing seed into the ground. The row crop planter generally includes a horizontal toolbar fixed to a hitch assembly for towing behind a tractor or other implement. Row units are mounted to the toolbar. In different configurations, seed may be stored at individual hoppers on each row unit, or it may be maintained in a central hopper and delivered to the row units on an as needed basis. The row units include ground-working tools for opening and closing a seed furrow, and a seed metering system for distributing seed to the seed furrow.

In its most basic form, the seed meter includes a housing, a seed disk, and a seed chute. The housing is constructed such that it creates a reservoir to hold a seed pool. The seed disk resides within the housing and rotates about a generally horizontal central axis. As the seed disk rotates, it passes through the seed pool where it picks up individual seeds. The seeds are subsequently dispensed into the seed chute where they drop into the seed furrow. The seed meters are given a location along a toolbar of a planter, and the location determines at least some functionality of the meter.

Planter settings and ambient conditions can cause planters to place seed less precisely than desired. It is difficult for a user to know how much performance will be affected by a given set of settings and ambient conditions before they start planting.

While planting, a user can discover that the settings and ambient conditions are causing the planter to perform non-optimally. Upon discovering that a planter is no longer performing as well as intended, it can be difficult to determine which of the settings and ambient conditions that are present are negatively affecting the seed placement. This makes identifying the causes of issues and then resolving those issues very difficult for a user.

When plants begin to emerge, days after planting, areas of poor seed placement become much easier to identify, but without data on what settings and conditions were present when planting those areas, it is hard to determine the cause of the poor performance and therefore hard to avoid the issue in the future.

Thus, there exists a need in the art for a device, such as a user display in a planter, to provide updated information related to expected planter performance, to provide better planter performance, and to adjust expectations of a user.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of aspects and/or embodiments shown and/or described in the present disclosure to combine multiple types of collected data into the expected planting quality value, which gives a user one piece of information to assess when making decisions.

It is another object, feature, and/or advantage of aspects and/or embodiments shown and/or described in the present disclosure to assist in making decisions which include, but are not limited to, updating the planter settings, delaying planting until ambient conditions are more favorable, or determining if issues need to be dealt with immediately before continuing planting or if planting can continue with minimal negative consequences.

It is still yet a further object, feature, and/or advantage of aspects and/or embodiments shown and/or described in the present disclosure to determine the expected planting quality via an expected planting quality indicator which can be used by the user, shared with experts, or shared with planter dealers and original equipment manufacturers (OEMs) to help with diagnosing issues, making purchasing decisions, making decisions about best planting practices, and by the OEMs to make a better product.

The methods and systems disclosed herein can be used in a wide variety of applications. For example, while the applications relate generally to the agricultural industry, this can include planting, spraying, seeding, or generally any other ground engaging application of a solid and/or liquid particulate to a field by an agricultural implement. For example, the present disclosure could be applied to the application of chemicals including, but not limited to, fertilizer, herbicide, pesticide, water, and the like. According to embodiments wherein the present disclosure is applied to chemical application, a metric could be determined and/or calculated wherein said metric is similar to the expected planting quality indicator described herein. Such a metric could be referred to as an expected chemical application quality indicator. This expected chemical application quality indicator could be determined and/or calculated in the same and/or similar manner as the expected planting quality indicator and could be used in the same and/or similar manner by an operator as the expected planting quality indicator is used by an operator for planting. Additionally, this expected chemical application quality indicator could be used to optimize and/or improve aspects of chemical application such as application rate of the chemical(s), the mixture of the chemical(s), and the like. The plurality of data types used to determine and/or calculate an expected chemical application quality indicator could comprise any data types used to determine and/calculate the expected planting quality indicator such as each of those data types shown in FIG. 5 including, but not limited to, implement/vehicle settings, ambient conditions, and the like. Such an expected chemical application quality indicator, and system thereof used to determine said expected chemical application quality indicator, could include and/or incorporate any aspects of any embodiments of the present disclosure.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the disclosed and will make it easier for a user to understand and utilize the information provided by a system.

The methods and/or systems described herein can be incorporated into larger systems or designs which accomplish some or all of the previously stated objectives. This can include, but is not limited to, display units in vehicles, handhelds, computers, tablets, phones, servers, cloud systems, or generally any other system or apparatus that includes a processor and/or computing application.

According to some aspects of the present disclosure, a method for estimating an expected planting quality indicator comprises: receiving, via a processor, a plurality of types of data associated with planting via an agricultural planting implement; combining, via the processor, the plurality of types of data to calculate an expected planting quality indicator; wherein the expected planting quality indicator is calculated by: determining an optimal planting quality indicator; and comparing the optimal planting quality value to the collected plurality of types of data associated with planting via the agricultural planting implement.

According to some aspects of the present disclosure, the method further comprises updating a setting of the agricultural planting implement based on the expected planting quality indicator.

According to some aspects of the present disclosure, the setting is updated automatically via the processor.

According to some aspects of the present disclosure, the method further comprises displaying the expected planting quality indicator on a display.

According to some aspects of the present disclosure, the method further comprises displaying a suggested change to one or more settings of the agricultural planting implement to improve the expected planting quality indicator.

According to some aspects of the present disclosure, the method further comprises storing the expected planting quality indicator and the plurality of types of data to a memory.

According to some aspects of the present disclosure, the method further comprises analyzing a plurality of expected planting quality indicators based upon the plurality of types of data to improve the agricultural planting implement.

According to some aspects of the present disclosure, at least one of the plurality of types of data comprises ambient weather conditions.

According to some aspects of the present disclosure, at least one of the plurality of types of data comprises GPS data.

According to some aspects of the present disclosure, a system for estimating an expected planting quality value comprises: a processor; a memory and/or a non-transitory computer readable medium that stores executable instructions that, when executed by the processor, perform operations, the operations comprising: collecting, via the processor, a plurality of types of data associated with planting via an agricultural planting implement; combining, via the processor, the plurality of types of data to calculate an expected planting quality value; wherein the expected planting quality value is calculated by: determining an optimal planting quality value; and comparing the optimal planting quality value to the collected plurality of types of data associated with planting via the agricultural planting implement.

According to some aspects of the present disclosure, the processor is part of a display.

According to some aspects of the present disclosure, the display is configured to display the expected planting quality value.

According to some aspects of the present disclosure, the display comprises a graphical user interface.

According to some aspects of the present disclosure, a user can make a change to one or more settings of the agricultural planting implement, via the graphical user interface, based upon the expected planting quality value.

According to some aspects of the present disclosure, the graphical user interface comprises a map, and wherein the expected planting quality value is shown relative to a location on the map.

According to some aspects of the present disclosure, the collected plurality of types of data and the expected planting quality value are saved in the memory and/or the non-transitory computer readable medium as a data pair comprising a location and the expected planting quality value.

According to some aspects of the present disclosure, a system for estimating an expected planting quality value of an agricultural planting implement comprises: at least one processor and at least one memory configured to implement a learning model, the learning model generated from training data, wherein the learning model is trained with a method comprising the steps of: reviewing a plurality of data types associated with planting via the agricultural planting implement; and identifying a classifier in the form of an expected planting quality value that corresponds to an operational quality of planting based upon the plurality of data types; and wherein the learning model is stored on one or more non-transitory computer readable media comprising instructions comprising: collecting, in real time, data associated with planting via the agricultural planting implement; and generating and displaying the expected planting quality value for the collected data via a display.

According to some aspects of the present disclosure, the expected planting quality value is stored on the at least one memory and/or the one or more non-transitory computer readable media.

According to some aspects of the present disclosure, the instructions of the one or more non-transitory computer readable media further comprise generating and displaying, via the display, suggestions for improving the expected planting quality value.

According to some aspects of the present disclosure, the plurality of data types comprises GPS data, ambient weather conditions, and settings of the agricultural planting implement.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a side elevation view of a tractor, such as the type used to pull an agricultural implement.

FIG. 2 is a perspective view of an agricultural planting implement, such as the type pulled by the tractor shown in FIG. 1.

FIG. 3 is an example a display unit for use with an agricultural planting implement, such as a display unit that includes information related to the operation of the agricultural planting implement.

FIG. 4 is another view of a display unit for use with an agricultural planting implement showing a planter moving through a field.

FIG. 5 is a schematic showing at least some aspects of some embodiments of a system for determining an expected planting quality indicator and mapping of the same.

FIG. 6 is a decision tree showing options of aspects and/or embodiments of the present disclosure.

FIG. 7A is another decision tree showing options of aspects and/or embodiments of planting according to the present disclosure.

FIG. 7B is another decision tree showing options of aspects and/or embodiments of decisions related to the present disclosure.

FIG. 7C is another decision tree showing options of aspects and/or embodiments of offseason decisions according to the present disclosure.

FIG. 8 is a schematic showing aspects and/or embodiments of a system for determining an expected quality planting indicator according to the present disclosure.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Unless defined otherwise, all technical and scientific terms used herein have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as “constructed”, “arranged”, “adapted”, “manufactured”, and the like.

Terms characterizing sequential order, a position, and/or an orientation are not limiting and are only referenced according to the views presented.

The term “invention” is not intended to refer to any single embodiment of the particular invention but encompass all possible embodiments as described in the specification and the claims.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “agricultural equipment” encompasses any type of machinery associated with the agriculture industry. For example, both agricultural vehicles and agricultural implements are encompassed by the term “agricultural equipment”.

The term “particulate material” shall be construed to have a broad meaning, and includes, but is not limited to grain, seed, fertilizer, insecticide, dust, pollen, rock, gravel, dirt, stock, or some combination thereof. Particulate material can be mixed with air to form airborne matter.

It should be appreciated that the disclosure, including any or all of the components disclosed herein, may be used with respect to an agricultural planting implement, but this should not be limiting to the disclosure. In addition, as will be understood, any of the aspects of any of the embodiments shown and/or described herein could be combined with one another to form any number of embodiments, whether expressly disclosed or not, which would be understood by one skilled in the art.

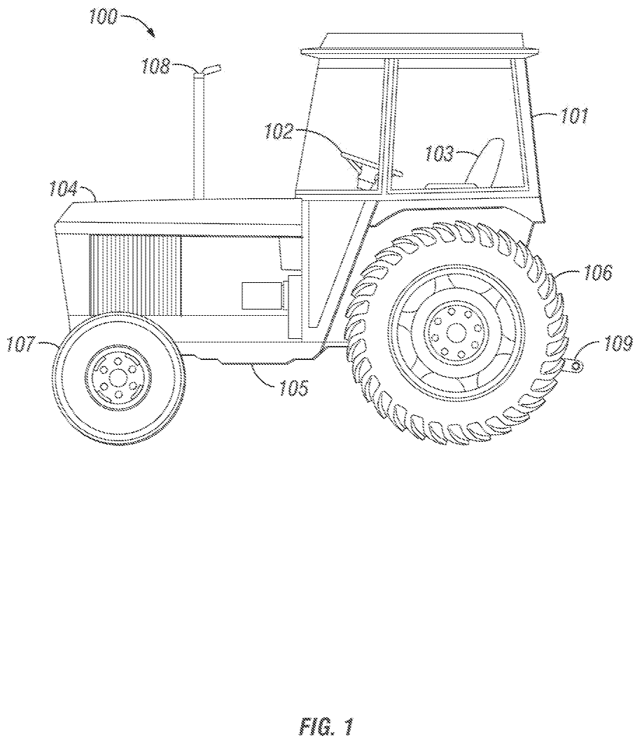

FIG. 1 shows a tractor 100 used for the purposes of towing machinery/implements used in agriculture. The tractor 100 includes a cab 101 with a steering wheel 102 and a seat 103 for an operator. The tractor 100 also includes a vehicle frame 104 which houses an engine located near the front axle of the tractor 100 and in front of the cab 101. The cab 101 and vehicle frame 104 are supported, structurally, by the tractor's chassis 105, which attaches to rear drivable wheels 106 and front steerable wheels 107, said front steerable wheels 107 operationally connected to the steering wheel 102. An exhaust pipe 108 allows carbon monoxide to exit the tractor 100 during operation of the engine. A tractor hitch 109 allows for connection between agricultural machinery and the tractor 100.

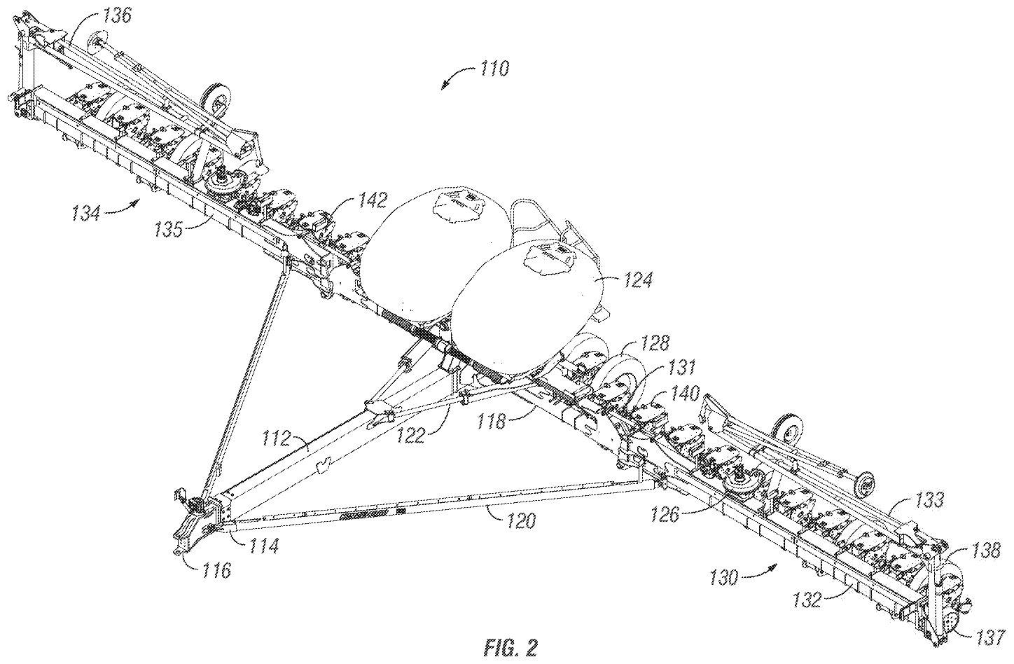

FIG. 2 shows an agricultural implement in the form of an agricultural planter 110 used to plant and fertilize seed in a controlled manner. For example, the planter 110 as shown in FIG. 2 includes a tongue 112, which may be telescoping. The tongue 112 includes a first end 114 with an implement hitch 116 for attaching to a tow vehicle, such as the tractor 100. The opposite end of the tongue 112 is attached to a frame or central toolbar 118. Draft links 120 are connected between the central toolbar 118 and the tongue 112 and are used in conjunction with folding actuators 122 to fold the central toolbar 118 in a frontward manner. Therefore, the tongue 112 maybe a telescoping tongue in that it can extend or track to allow for the front folding of the central toolbar 118. The planter 110 may also be a lift and rotate, rear fold, vertical fold, narrow row, or generally any other type of planter.

The central toolbar 118 includes first and second wings 130, 134 extending therefrom. The central toolbar 118 includes central hoppers 124 which contain seed or other granules/particulate used with planting. A plurality of transport wheels 128 also are connected to the central toolbar 118. The first and second wings 130, 134 are generally mirror images of one another. The wings include first and second wing toolbars 132, 135. Attached along the central toolbar 118 as well as the first and second wing toolbar 132, 135, are a plurality of row units 140. The row units include seed meters 142, ground engaging tools, and/or other components used for planting, tilling, and/or fertilizing seed in a controlled manner. Also connected to the first and second wings 130, 134 are first and second markers 133, 136. The markers include actuators 137, which are used to raise and lower the markers 133, 136. The markers 133, 136 can be lowered to provide guidance for the edge of a planter for use in planting. When not required, the markers can be lifted to a position as that shown in FIG. 2 to move the markers out of the way.

Also shown in FIG. 2 are a plurality of fans 126 as well as a plurality of wheels 138. The wings may also include actuators 131 to raise and lower or otherwise provide a downward force on the wings. Therefore, as is shown in FIG. 2, there are a multiplicity of components of the planting implement 110. The components may include moving parts, such as the actuators used to move the wings, markers, row units, etc., while also providing additional functions. For example, the fans 126 are used to provide a pressure in the seed meters 142 to aid in adhering seed to a seed disk moving therein. The seed meters may be electrically driven in that a motor, such as a stepper motor, can be used to rotate the seed meters to aid in adhering seed thereto and to provide for dispensing of the seed in a controlled manner for ideal spacing, population, and/or placement. Other features may include actuators or other mechanisms for providing down force to the row units 140. Lights may also be included as part of the planter.

Additionally, an air seed delivery system may be provided between the central hoppers 124 and any plurality of seed meters 142 on the row units 140 wherein the air seed delivery system provides a continued flow of seed to the row units in an as needed manner to allow for the continuous planting of the seed via the seed meters on the row units. Thus, the various controls of the planter may require or otherwise be aided by the use of an implement control system. The implement control system can aid in controlling each of the functions of the implement or planter 110 so as to allow for the seamless or near seamless operation of the implement, and also provide for the communication and/or transmission of data, status, and/or other information between the components.

As will be appreciated, the planter need not include all of the features disclosed herein and may also include additional or alternative features as those shown and/or described. The foregoing has been included as an exemplary planter, and it should be appreciated that generally any planter from any manufacturer and any add-ons or aftermarket components may be included in any planter that encompasses any of the aspects of the invention.

Therefore, a planter 110 such as that shown, can be pulled by the tow vehicle, such as the tractor 100 of FIG. 1. In addition, the planter 110 could be pulled by a self-propelled, autonomous tug unit, rather than an operator-driven vehicle, such as the tractor, such as the one shown and described in co-owned U.S. Pat. No. 10,575,453, which is herein incorporated by reference in its entirety. The rear drivable wheels and front steerable wheels can be substituted for tracks, regardless of whether said tracks are implemented on an operator-driven vehicle or a self-propelled vehicle.

Aspects of the operation of the planter 110, including any operation associated with any of the electronic or mechanical components thereof, can be controlled and/or viewed on a display unit, which may be positioned in the cab 101 of the tractor 100 or located remote of the planter and/or tractor. The display unit may also be referred to as a user interface unit, monitor and input unit, monitor unit, interactive display, or other relative term. The display unit is configured to be used with an agricultural implement, while being remote from an agricultural implement. For example, it is contemplated that the display unit be in communication, such as electronic communication, with a planter. An operator can utilize the display unit remote from the planter, such as in a tractor or other tow vehicle that is connected to the planter. The display unit can be displayed within the tow vehicle, but is also configured to be removable therefrom, thus creating a portable unit.

The display unit can take many forms and can generally be considered or can comprise an intelligent control and a user interface. For example, an intelligent control is generally considered to be a computer readable medium or computing device or an apparatus including a processing unit. Examples of such units can be tablets, computers, servers, cell phones, or generally any other handheld, portable, permanent, or other device which may include a central processing unit and a graphical user interface (“GUI”). The graphical user interface may also be a user interface (“UI”) without the graphics required. A user interface is how the user interacts with a machine. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

Additional aspects of the display unit can include connections to wires to be able to communicate electronically to the planter. Still further, it is contemplated that the unit be able to communicate in a wireless fashion, such as via any wireless connection. This can include, but is not limited to Bluetooth, Wi-Fi, cellular data, radio waves, satellite, or generally any other form of wireless connection which will allow for communication between the unit and the planter. Therefore, the unit will include generally any electronic components necessary to allow for such wireless or wired communication. The wired communication can take the form of CAN bus, Ethernet, co-axial cable, fiber optic line, or generally any other line which will allow for communication between the unit and the implement and/or planter.

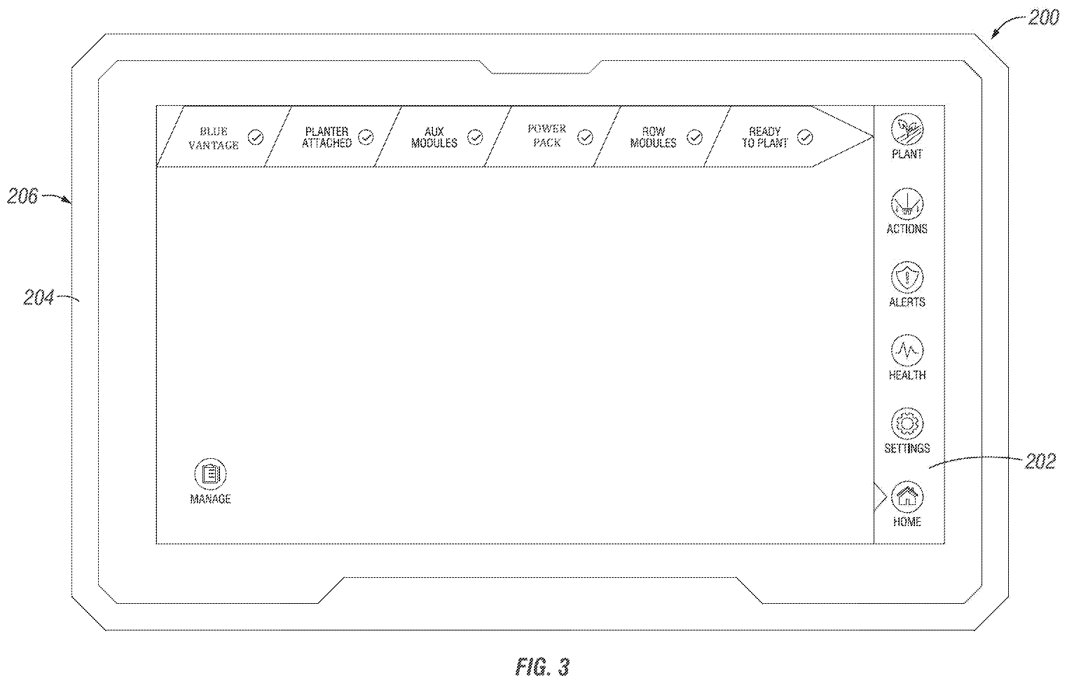

An exemplary depiction of a display unit 200, such as may be used with any or all of the aspects and/or embodiments disclosed herein is shown generally in FIG. 3. It should be appreciated, as had been disclosed, that the display unit 200 shown in FIG. 3 is for exemplary purposes and is not to be limiting on the invention. However, as shown, the display unit 200 includes a screen area 202 surrounded by a fascia or frame 204, which may be a part of the housing 206 of the display unit 200. The display unit 200 shown in FIG. 3 and others includes a colorized, graphical user interface, showing both colorized icons and images. In addition, it is noted that the display unit 200 shown in the figures comprises a touchscreen, allowing the display unit 200 to be interfaced via a touch by a user. This could be with an appendage, such as a finger, or a conduit, such as a stylus or other device. In the configuration shown, the housing/fascia 206/204 does not include any interfaces, such as inputs, but it is envisioned that buttons, knobs, or the like be included in the housing/fascia 206/204 outside of the screen area 202 to provide input options and other interfaces for controlling and/or inputting information via the display unit 200.

Additionally, while not shown, it is to be appreciated that the display unit 200 includes a processor, non-transitory computer readable medium, modules/programs, memory, operating system, database, power supply, communications/networks, and/or a number of inputs and/or outputs.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

The display unit 200 will preferably include an intelligent control (i.e., a controller) and components for establishing communications. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc. According to some embodiments, the intelligent control of the display unit 200 can comprise one or more processors/processing units.

Generally, the non-transitory computer readable medium operates under control of an operating system stored in the memory. The non-transitory computer readable medium implements a compiler which allows a software application written in a programming language such as COBOL, C++, FORTRAN, or any other known programming language to be translated into code readable by a processing unit, which could be a central processing unit and/or intelligent control. After completion, the processing unit accesses and manipulates data stored in the memory of the non-transitory computer readable medium using the relationships and logic dictated by the software application and generated using the compiler.

In at least one embodiment, the software application and the compiler are tangibly embodied in the computer-readable medium. When the instructions are read and executed by the non-transitory computer readable medium, the non-transitory computer readable medium performs the steps necessary to implement and/or use at least some aspects of at least some embodiments of the present disclosure. A software application, operating instructions, and/or firmware (semi-permanent software programmed into read-only memory) may also be tangibly embodied in the memory and/or data communication devices, thereby making the software application a product or article of manufacture according to the present disclosure.

For example, according to some embodiments, the non-transitory computer readable media can store executable instructions that can be performed by a processor/processing unit wherein such instructions can comprise collecting a plurality of types of data associated with planting via an agricultural planting implement, combining the plurality of types of data to calculate an expected planting quality value, and displaying the expected planting quality value, wherein the expected planting quality value is calculated by: determining an optimal planting quality value and comparing the optimal planting quality value to the collected plurality of types of data associated with planting via the agricultural planting implement.

The database is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

The power supply outputs a particular voltage to a device or component or components of a device. The power supply could be a direct current (“DC”) power supply (e.g., a battery), an alternating current (“AC”) power supply, a linear regulator, etc. The power supply can be configured with a microcontroller to receive power from other grid-independent power sources, such as a generator or solar panel.

With respect to batteries, a dry cell battery may be used. Additionally, the battery may be rechargeable, such as a lead-acid battery, a low self-discharge nickel metal hydride battery (“LSD-NiMH”), a nickel—cadmium battery (“NiCd”), a lithium-ion battery, or a lithium-ion polymer (“LiPo”) battery. Careful attention should be taken if using a lithium-ion battery or a LiPo battery to avoid the risk of unexpected ignition from the heat generated by the battery. While such incidents are rare, they can be minimized via appropriate design, installation, procedures and layers of safeguards such that the risk is acceptable.

The power supply could also be driven by a power generating system, such as a dynamo using a commutator or through electromagnetic induction. Electromagnetic induction eliminates the need for batteries or dynamo systems but requires a magnet to be placed on a moving component of the system.

According to some embodiments, the power supply may also include an emergency stop feature, also known as a “kill switch,” to shut off machinery in an emergency situation. According to some embodiments, the power supply could include any other safety mechanisms known to prevent injury to users of a machine. The emergency stop feature or other safety mechanisms may need user input or may use automatic sensors to detect and determine when to take a specific course of action for safety purposes.

In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. The network typically allows communication between a communications module and a central location during moments of low-quality connections. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

ISO 11783, known as Tractors and machinery for agriculture and forestry—Serial control and communications data network (commonly referred to as “ISO Bus” or “ISOBUS”) is a communication protocol for the agriculture industry based on the SAE J1939 protocol (which includes CAN bus). The standard comes in 14 parts: ISO 11783-1: General standard for mobile data communication; ISO 11783-2: Physical layer; ISO 11783-3: Data link layer; ISO 11783-4: Network layer; ISO 11783-5: Network management; ISO 11783-6: Virtual terminal; ISO 11783-7: Implement messages application layer; ISO 11783-8: Power train messages; ISO 11783-9: Tractor ECU; ISO 11783-10: Task controller and management information system data interchange; ISO 11783-11: Mobile data element dictionary; ISO 11783-12: Diagnostics services; ISO 11783-13: File server; ISO 11783-14: Sequence control.

Ethernet is a family of computer networking technologies commonly used in local area networks (“LAN”), metropolitan area networks (“MAN”) and wide area networks (“WAN”). Systems communicating over Ethernet divide a stream of data into shorter pieces called frames. Each frame contains source and destination addresses, and error-checking data so that damaged frames can be detected and discarded; most often, higher-layer protocols trigger retransmission of lost frames. As per the OSI model, Ethernet provides services up to and including the data link layer. Ethernet was first standardized under the Institute of Electrical and Electronics Engineers (“IEEE”) 802.3 working group/collection of IEEE standards produced by the working group defining the physical layer and data link layer's media access control (“MAC”) of wired Ethernet. Ethernet has since been refined to support higher bit rates, a greater number of nodes, and longer link distances, but retains much backward compatibility. Ethernet has industrial application and interworks well with Wi-Fi. The Internet Protocol (“IP”) is commonly carried over Ethernet and so it is considered one of the key technologies that make up the Internet.

The Internet Protocol (“IP”) is the principal communications protocol in the Internet protocol suite for relaying datagrams across network boundaries. Its routing function enables internetworking, and essentially establishes the Internet. IP has the task of delivering packets from the source host to the destination host solely based on the IP addresses in the packet headers. For this purpose, IP defines packet structures that encapsulate the data to be delivered. It also defines addressing methods that are used to label the datagram with source and destination information.

The Transmission Control Protocol (“TCP”) is one of the main protocols of the Internet protocol suite. It originated in the initial network implementation in which it complemented the IP. Therefore, the entire suite is commonly referred to as TCP/IP. TCP provides reliable, ordered, and error-checked delivery of a stream of octets (bytes) between applications running on hosts communicating via an IP network. Major internet applications such as the World Wide Web, email, remote administration, and file transfer rely on TCP, which is part of the Transport Layer of the TCP/IP suite.

Transport Layer Security, and its predecessor Secure Sockets Layer (“SSL/TLS”), often runs on top of TCP. SSL/TLS are cryptographic protocols designed to provide communications security over a computer network. Several versions of the protocols find widespread use in applications such as web browsing, email, instant messaging, and voice over IP (“VoIP”). Websites can use TLS to secure all communications between their servers and web browsers.

Each of the networks and communications methods/protocols described herein could be used by aspects of the present disclosure according to various embodiments.

In some embodiments, the display unit 200, or other device, could include one or more communications ports such as Ethernet, serial advanced technology attachment (“SATA”), universal serial bus (“USB”), or integrated drive electronics (“IDE”), for transferring, receiving, and/or storing data.

In some embodiments, a satellite-based radio-navigation system such as the global positioning system (“GPS”) is used. GPS is owned by the United States and uses satellites to provide geolocation information to a GPS receiver. GPS, and other satellite-based radio-navigation systems, can be used for location positioning, navigation, tracking, and mapping.

Referring back to FIG. 3, the display 200 includes a number of icons and toolbars, for example, the toolbar across the upper portion of the display 200 and the toolbar with icons along the right side of the display 200, which can lead to additional screens, will provide more options and inputs.

Still further, it should be appreciated that at least some aspects of some embodiments disclosed herein be on other devices, such as phones, handhelds, tablets, computers, processors, or the like. The information can be transmitted from a planter or other implement to the device via wired communication and/or wirelessly, and can be included as part of a farm management system. As will be understood, the information can be used in real time or at a later date/time in order to provide information related to the agricultural implement (e.g., planter 110) and/or use thereof. Such information can relate to the quality of operation of the planter and can include possible outputs for the operation of the equipment, as well as information on how to better operate the system.

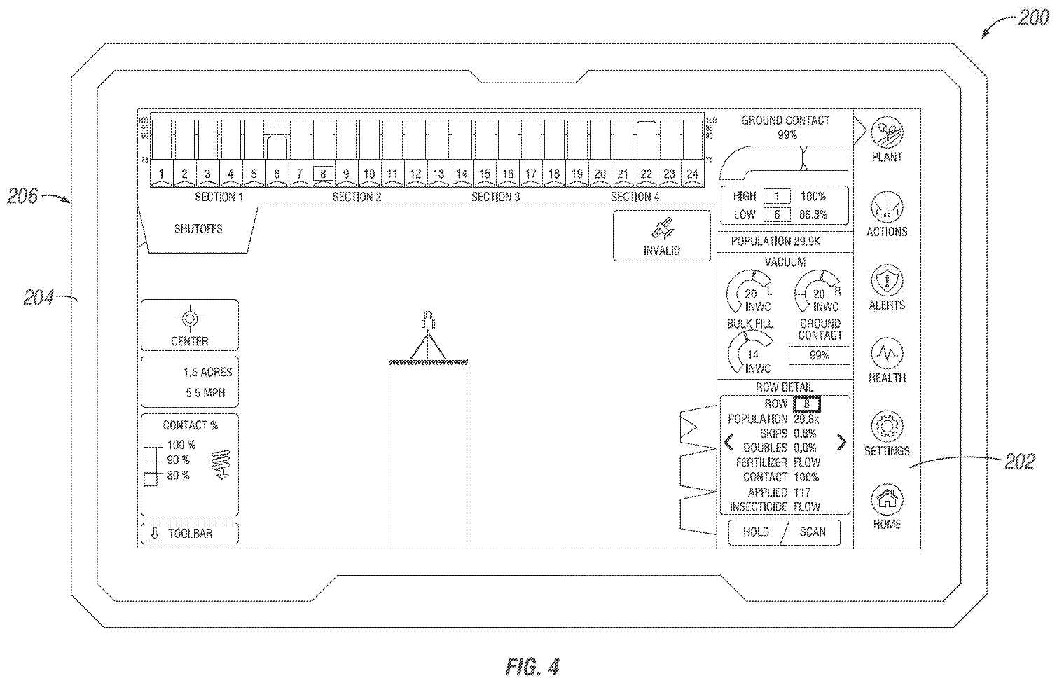

FIG. 4 is a depiction of the display 200 used during planting by a planting implement. The display screen 202 has changed to show a graphical depiction of a tractor and a planter moving through an exemplary field. A number of icons, sections, and other portions of the display screen 202 include information related to the planting and movement of the tractor and implement. This includes, but is not limited to, speed, heading, downforce information (contact %), row unit information, population, planting information, etc. This is in the form of numbers, text, percentages, colorized information, and combinations of the same. As will be understood, the screen 202 can be changed, such as per user preference, to selectively show desired information and to shuffle through various screens. Nonlimiting examples include that the user can look at issues/warnings that may be indicated by the system, can look at help guides and/or manuals for operation instructions, can look at field information, can look at and modify settings of the system, planting implement, or display unit 200, can look at health information related to the planting implement, and/or can even make changes to one or more components of the planting system. For example, changes can be made to accommodate planting preferences, information shown/displayed, or to run diagnostics.

One piece of information shown on the display unit 200, such as that shown in the figures, relates to the quality of operation. For example, seed spacing, singulation information (such as skips and/or doubles), seed population information, or other information showing the desired or set planting conditions versus what is actually happening can be shown. Users have an expectation that these settings will be met or closely missed (e.g., 95%+ of singulation, or optimal seed spacing). When the display shows that the actual readings from sensors and other components on the planter is not meeting the set/desired settings for planting, the operator may think that the implement or some other component is not operating appropriately, or that there may be other issues occurring. What they may be missing is that certain settings, conditions, or other factors may actually limit the performance of the implement, and that the performance could be improved in some instances, or may require significant changes to show improvement. However, without the information as to the performance limitations, the users will not know and may think it is an issue with the equipment itself.

Therefore, as will be understood, at least some aspects of some embodiments of the present disclosure relate to the identification of an “expected planting quality” indicator that provides performance information/limitations to a user. In addition, the system may provide guidance or information to help improve the expected planting quality indicator to provide a better user experience. Many planter settings and ambient conditions, such as GPS quality and/or data, can be used to predict that a planter will perform less than optimally. Presenting these predictions to the user with an “expected planting quality” indicator lets the user know if they are “good to plant” or if there are planter settings or ambient conditions that will negatively affect planter performance. This allows users to decide whether to make changes to the planter, allows user to decide to delay planting until better ambient conditions are present, and/or gives users a reasonable expectation of possible efficiency of the planter.

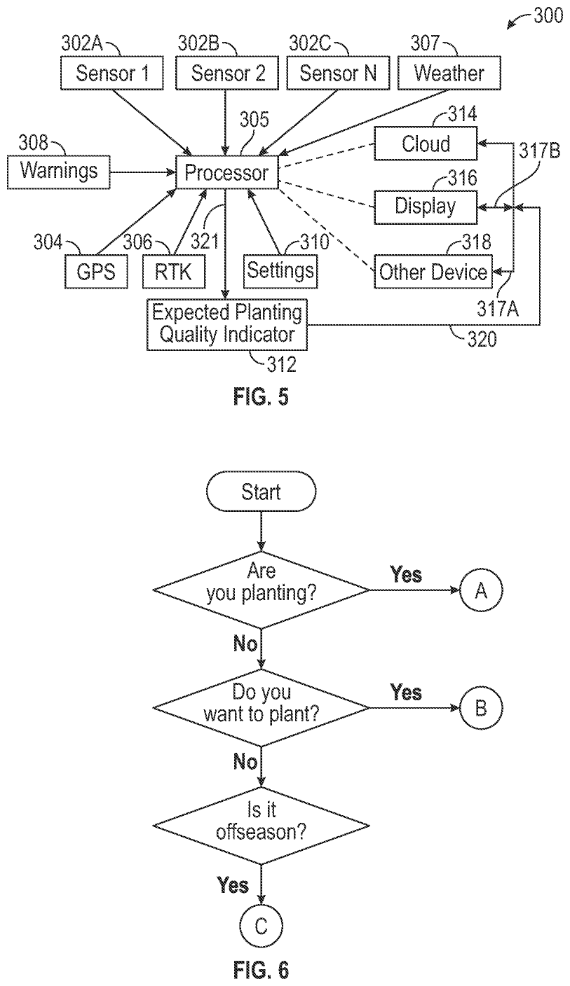

Changes to this expected planting quality indicator can be observed in real time, such as on a screen of a display unit 200 shown in FIG. 3 or 4, in an on-the-go manner while planting and also stored by GPS position as the planter traverses the field. This information can be shown via a map (similar to that shown in FIG. 4) so that the varying expected planting quality in a field can be easily viewed over a large area. The expected planting quality indicator can be shown relative to a location on a map. Also, an expected planting quality indicator and associated collected data (such as that shown in FIG. 5) can be stored in memory together as a data pair such that the data pair comprises the expected planting quality indicator and the location to which the expected planting quality indicator refers.

Planter settings and ambient conditions that contribute to the expected planting quality value could also be recorded by GPS position separately from the expected planting quality value, so that they could be viewed on the map in isolation from the other values.

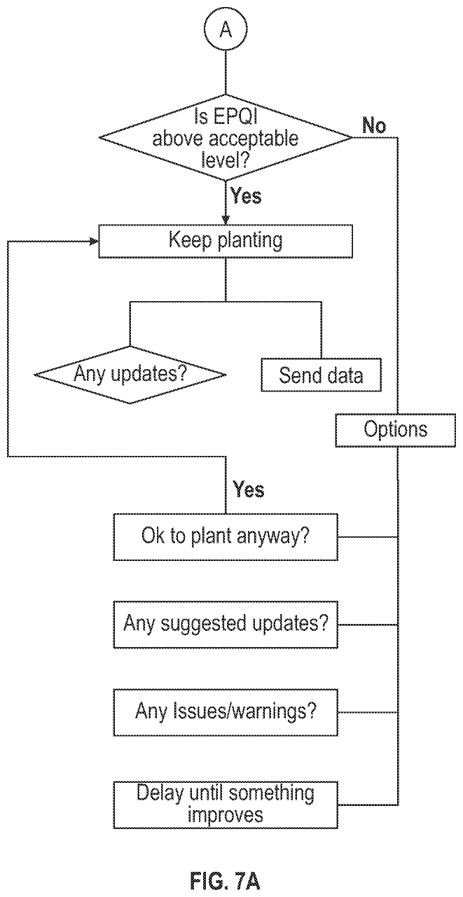

FIG. 5 shows an example of a system 300 for determining an expected planting quality indicator and mapping of the same. The system 300 shown in FIG. 5 shows many possible inputs and exports for the system 300, which, when viewed in combination with the exporting and logic model of FIG. 6, indicates at least some uses for the output of the system 300. According to some embodiments, any and/or all of the inputs to the system 300 and/or processor 305 can be combined and/or used, by the processor 305 and/or components thereof, to determine, calculate, optimize, and/or improve the expected planting quality indicator.

The system 300 includes a processor 305, which may be any type of intelligent control, controller, or the like, which may include a processing unit and associated components. While the processor 305 of FIG. 5 is referred to herein as a singular “processor”, according to some embodiments, the processor 305 could comprise any number of processors/processing units ranging from 1 to N where N is any number greater than 1. The processor 305 is shown to be electronically connected to a number of inputs, which are shown by the arrows from the inputs to the processor. While a number of inputs are shown, these should not be limiting to the present disclosure, and it should be appreciated that any input that could provide information to the system 300 is to be considered part of the present disclosure.

The figure shows sensors, such as Sensor1 302A, Sensor2 302B, and SensorN 302C, wherein the “N” stands for any number of sensors of an agricultural system. Thus, the number of sensors could range from zero to N where N is any number greater than zero. Modules can be placed on and around the agricultural implement and/or tractor and include various sensors to provide information to the intelligent control/processor 305. As an example, the tractor 100 and/or the planter 110 could be included as part of the system 300. The sensors may include vision sensors, radar sensors, LIDAR sensors, heat sensors, moisture content sensors, radio frequency sensors, short-range radio, long-range radio, antennas, and the like. These sensors can be grouped in any manner and can be used to determine many aspects. For example, the sensors can be used to determine the location of the agricultural implement and/or tractor or could be used to determine the location of a nearby object or obstruction. The sensors may be used to determine soil characteristics, such as moisture content, compaction, temperature, and the like. The sensors can also be location sensors to determine if the agricultural implement is on level ground, on a side hill, going up or down hill, etc. The location sensors can also determine areas in which the implement is not to travel, based upon pre-determined and/or programmed data. One or more sensors may be included with a row unit, such as to detect seed being planted by the row unit. The sensor may be in the seed meter, the seed conveyance system (seed-to-ground system), or otherwise included. For exemplary purposes, a sensor in a seed tube used to deliver seed from a meter to a furrow in the ground will be disclosed.

The seed sensor for the gravity drop seed tube is in the elements. Thus, the sensor can be exposed to soil and other materials as the planter moves through the field. The sensor, which may be a light-based sensor, can be affected by the buildup of soil or other material on one or more portions of the sensor. For example, build up on the transmitter, receiver, and/or transceiver, may affect the ability to detect seed and/or determine the difference between seed passing by the sensor and other material, such as soil, fertilizer, or the like. To account for this buildup, the sensor may self-adjust to take into account the buildup. This can be in the form of increasing or decreasing sensitivity levels, or to adjust the amount of information required to determine material passing thereby. This can continue until such time that an operator or user is able to clean off (wipe) the surfaces of the sensor components.

However, an issue may also occur once the sensor components are cleaned of the buildup. As noted, the sensor has self-adjusted to account for the buildup. Once the buildup has been cleansed, the clean sensor may not be calibrated accordingly, and thus, may include errors in the signals.

The sensors could also be used with location determining systems, such as GPS 304 and/or real-time kinematic positioning (RTK) 306. These inputs, along with the tractor, can provide information related to heading, speed, etc.

Additional inputs for the system 300 include a weather device 307. Such a weather device can provide information related to ambient conditions (temperature, humidity, precipitation, pressure, wind speed/direction, etc.). The weather device 307 could also include forecasting, such as to provide predicted future weather conditions. The weather device 307 can incorporate a weather application and/or connection to a weather service/station.

The system 300 includes any number of warnings 308, which relate to a status of one or more components of the implement. This can include parts that are worn and/or have suffered wear and tear, parts needing calibration, dirty sensors, or other information indicating that the components may be working sub-optimally. The system 300 can include settings 310 of the agricultural implement and/or any other settings. The settings 310 relate to settings inputted by the user or selected automatically by the control system of the implement. This can include speed, downforce, seed spacing, row unit spacing, seed population, and/or any other variable that is adjustable for the implement.

As noted, all of the inputs of the system 300 are provided to the processor 305 for a determination of the best possible output of the implement which can be reflected in an expected planting quality value or indicator 312. One advantage of the present disclosure is that it combines multiple types of collected data into the expected planting quality value or indicator 312, which gives a user a single piece of information to assess when making decisions. This is indicated by the arrow 321. Since the expected planting quality value or indicator 312 represents a single value, it can simplify the user's decision making.

According to some embodiments, the system 300 can determine and/or calculate the expected planting quality indicator 312 by first determining and/or calculating an optimal planting quality indicator, which can be an optimal planting quality indicator in general or can be an optimal planting quality indicator based on the settings of the agricultural planting implement. The system 300 can then compare the optimal planting quality indicator to the collected plurality of data types (which can include any and/or all inputs to the system 300 and/or processor 305 such as those shown in FIG. 5) to determine and/or calculate the expected planting quality indicator 312. In some embodiments, once an optimal planting quality indicator is determined and/or calculated in general, the system 300 can then factor in and/or account for the collected plurality of data types (which can include any and/or all inputs to the system 300 and/or processor 305 such as those shown in FIG. 5) to determine and/or calculate the expected planting quality indicator 312. In some embodiments, once an optimal planting quality indicator is determined and/or calculated based on settings of the agricultural planting implement, the system 300 can then factor in and/or account for the collected plurality of data types (which can include any and/or all inputs to the system 300 and/or processor 305 such as those shown in FIG. 5) to determine and/or calculate the expected planting quality indicator 312.

Additional aspects of the system 300 include the location of the processor 305. This is shown generally by the dashed lines between the processor 305 and the cloud based processor 314, the display 316, or other devices 318 (other devices being generally any other component having a processing unit, such as a computer, handheld, tablet, server, smart device, or the like). In other words, the processor 305 can be positioned with the implement and/or tractor, such as wired connectivity between the inputs and the processor 305 or can be wireless and remote. A cloud based processor 314 would allow for the inputs to be sent to a cloud based system, wherein the expected planting quality indicator 312 would be determined. This could then be sent back to the implement/tractor. The information could also be sent to a farm management system, which may be on a computer 318 remote from the implement, where it is calculated. In addition, the processing unit 305 may be part of the display 316 that is in or on the tractor, which provides real time feedback for the user.

Still further, it is to be appreciated that the system 300 includes all of the processors (i.e., the cloud based processor 314, the display 316, and any other device 318). In such a situation, it is to be appreciated that the components could all be connected to one another, such as wired or wirelessly, to share the information with one another. Thus, the expected planting quality indicator 312 could be determined at any or all of the locations, and then shared to the others. This is shown by the arrows 317A and 317B, which shows bilateral communication for the information from any and all of the devices.

Once the expected planting quality indicator 312 has been determined from the inputs, it can be sent to a display on any of the devices, including but not limited to a cloud based processor/display/system 314, a display in the tractor 316, or other processing devices 318 (such as part of a farm management system). The expected planting quality indicator 312 can be mapped on any or all of the devices to provide the information to users, such that they can track and make decisions based upon such information. This is shown generally by the arrow 320, which shows the indicator 312 being sent to the various devices.

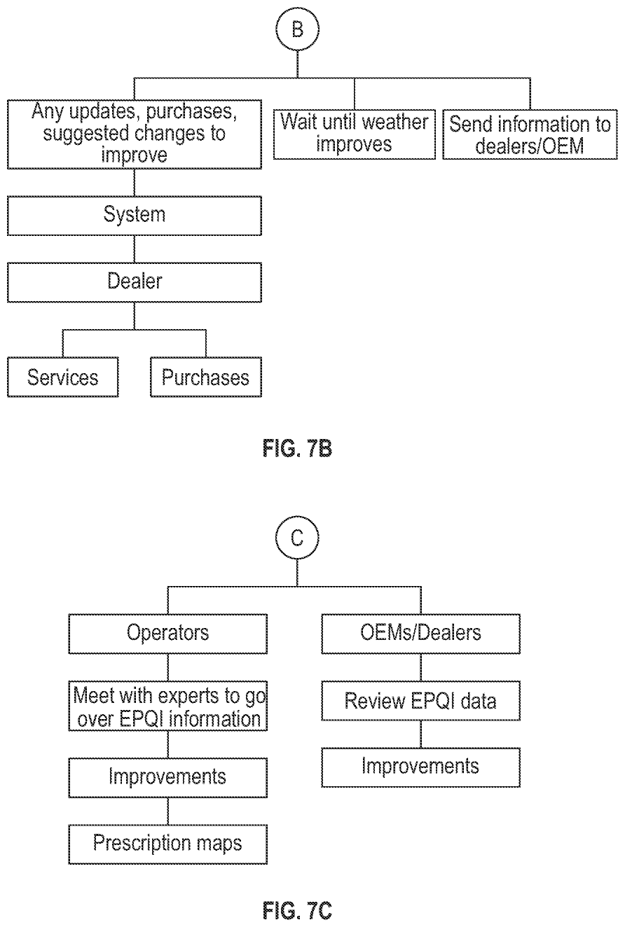

As shown in FIGS. 6, 7A, 7B, and 7C, there are various paths and/or determinations that can be made using the information of the expected planter quality indicator (EPQI), such as that which is determined and/or mapped as disclosed herein.

For example, starting with FIG. 6, the decision starts and asks if an operator/system is planting. If yes, the decisions move to the diagram of FIG. 7A (by going to the letter A in FIG. 6). As shown in FIG. 7A, the first determination is if the EPQI is at or above an acceptable level. As noted, the EPQI will be determined based upon a number of inputs and factors. This will be indicative of the expected quality of planting, including, but not limited to, expected singulation, population, spacing, downforce, planted depth, etc. If the system 300 and ambient conditions suggest that the planter will operate at a normal or acceptable level, the diagram indicates to continue planting/operating as normal. In addition, the system 300 (e.g., the display) will provide suggested updates for maintaining or improving the EPQI, which can be set to automatically occur or to be required to be accepted to be implemented. In addition, the system 300 will allow the data to be sent to dealers and/or OEMs (original equipment manufacturers) for review and improvements to the system 300.

If the EPQI is not at or above an acceptable level, as shown in FIG. 7A, the next step may be to review options and/or pursue one or more of said options. The options include, but are not limited to, continuing to plant anyway. There are definitely times when the planting must continue. This can be due to time of year, delays, amount of planting left versus ability to delay, etc. In such instances, the operator can continue to plant even knowing that the EPQI provides information that the planting conditions may be less than ideal, or at least less than intended. For whatever reason(s), including but not limited to, implement settings, weather conditions, wear and tear on components, not having the proper/updated equipment, or the like, one or more settings for planting may have a greater chance of not being met. The operator can simply choose to ignore this and continue planting and then evaluate at a later time and/or determine if the sown crop has been limited based on the decision to continue planting. If the operator chooses to ignore the less than acceptable/ideal EPQI and continue planting, according to some embodiments, the system 300 (e.g., the display) can provide suggested updates for maintaining or improving the EPQI as described above. Additionally, if an operator chooses to keep planting despite the less than acceptable/ideal EPQI, the system 300 can send data to dealers and/or OEMs for review and improvements to the system 300 as described above.

Other options if the EPQI is not at or above an acceptable level include the system 300, such as via a display, providing suggestions for improving the EPQI. This can be suggested settings changes, suggested cleanings for components, suggested replacement or upgrade of components, or other suggested changes that can be made to potentially increase the EPQI for planting. In some instances, the system 300 can be set up to automatically institute changes to settings that will provide the greatest possible EPQI based upon desired settings. For example, a user may apply a desired spacing or population count or may set a speed to make sure to complete planting. The system 300 can autodetect this and automatically adjust settings to provide the highest possible EPQI for the settings.

The system 300 may also indicate issues or warnings that may be affecting the EPQI as is shown in FIG. 7A. These can be in the form of component failure or other issues (e.g., wear and tear, calibration issues, plugging, etc.), or can be in the form of limitations of a particular set up. For example, the system 300 may recognize that, based upon a user's inputs for planting settings, the EPQI is limited based upon the state of the equipment itself. This could be an outdated part/component or could be that the user is operating an implement that does not include all or necessary options for operating at the optimum level. The system 300 can alert the user to provide ways to improve the EPQI, which can be in the form of maintenance, upgrades, or other changes. For example, the system 300 may provide suggested upgrades that can be made by a dealer and let the user request such updates before operating. A dealer could be notified, and the required steps be taken to upgrade the planting implement and/or system 300. The dealer may also be requested for service needs of the implement to increase the EPQI and can be summoned accordingly.

Still further, the system 300 may detect that a weather condition, such as heat, humidity, or some other factor, is causing the implement to operate with a less than ideal EPQI. The system 300 may simply suggest waiting until said weather condition(s) has improved in order to continue planting as is shown in FIG. 7A. According to some embodiments, the system 300 may suggest waiting until any condition and/or factor that is negatively affecting the EPQI has improved in order to continue planting.

However, it should be noted that these are not the only ways to move forward when a less than acceptable/ideal EPQI has been indicated, and other options obvious to those skilled are to be considered a part of the present disclosure.

Referring back to FIG. 6, one of the queries is if an operator is wanting to use the implement, i.e., wanting to plant. This is shown by the letter B, which is shown in FIG. 7B. The diagram shown in FIG. 7B is similar to part of FIG. 7A when the EPQI is lower than a preferred level. However, the difference is that in FIG. 7B, the planting is not currently happening. Instead, there is a desire to plant, but there may be some choices in order to attempt to increase the EPQI before starting to operate/plant.

As shown in the figure, one option may be to check if any updates, purchases, or potential changes could improve the EPQI. This could be an upgrade to a part or component, such as from a dealer or OEM, a software upgrade, or other change. According to at least some aspects of some embodiments, the options may be provided directly as part of the system 300, such as via a display, wherein a request for upgrade or service could be sent to a dealer for improvement. The connectivity of the system 300 could relay such a request to the dealer, who could then provide the purchase and/or service before operating/planting, which should increase the EPQI. The dealer or a technician of the dealer could make the necessary services to the equipment, especially if there is an issue related to a component of the implement.

Another option may be to simply wait, such as to wait to see if there is a change in ambient conditions, such as the weather. The weather may affect the EPQI, and the system 300 can include a weather application or connection to a weather service/station, which could include a forecast. The system 300 could alert the operator to wait until a specified time period that forecasts a change in the weather, which would likely increase the EPQI. This could be shown as part of the field map on a display, which could include an overlay of the forecast. An hour-by-hour depiction with associated estimated EPQI could also be shown on the display to let the user known when it may be best, from a weather perspective, to operate.

Finally, FIG. 7B also shows that any of the information could be sent automatically, or manually by the user, to a dealer or OEM. This information could be used to improve the system 300, including any suggestions in the future, for operation of the implement with the best possible EPQI. The information could be used by the dealer/OEM to implement best practices and for feedback. The information could further be used by the dealer/OEM to help with diagnosing issues, making purchasing decisions, and/or to develop better product(s).

FIG. 6 also shows a path for when the operator is reviewing the system 300 and not intending to plant/operate, such as due to it being the offseason. The offseason is meant to refer to a time unrelated to operation. This could be a time outside the weeks/months for planting, when the implement may be serviced, stored, or otherwise evaluated, and is shown by the letter C, which refers to FIG. 7C.

FIG. 7C shows multiple paths for optimizing the system 300 in the offseason. The first relates to a path for the user/operator. The information related to the EPQI can be reviewed by the user, such as with one or more experts, to fine tune and/or plan for future use. For example, an operator could go over EPQI data along with reasons for the number, either with or without yield data from associated crops with an agronomist, dealer, OEM representative, or other expert. The meeting could be used for teaching to show how the EPQI could have been improved, which could have improved yield. Meeting with an expert also allows an operator to ask questions regarding any aspects of planting and/or the system 300 and receive answers from the expert as well as allowing the expert to make suggestions and/or offer comments regarding ways to improve planting. Oftentimes, a user may be time-crunched to finish an operation and may not appreciate why a change or changes could have improved performance. Taking the time to go over this information could be beneficial for future seasons.

In addition, such a meeting could help create prescription maps for future planting seasons, as well as other in-farm operations, such as tilling, sowing, spraying, cultivating, or the like. There may be reasons outside of the norm as to why the EPQI was lower than desired, such as field conditions, farm conditions, weather issues, or the like, which may not be appreciated without input from the operator, and this meeting would provide such information for a better system.

The other path for offseason data handling involves the dealers and OEMs. The OEMs and/or dealers can review the information related to the EPQI, such as in view of settings, ambient conditions, location information, or any other information to determine if there is a way to improve in the future. This could be in the form of software updates, equipment updates, suggested changes, or any other way that could improve the EPQI at the convenience of the user/operator, which will provide a better product, and hopefully, better results (i.e., higher yield).

It should be noted that while EPQI data can be gathered, generated, and/or displayed/communicated in real time in an on-the-go manner, all aspects of such EPQI data, including mapping, can also be stored and used/reviewed/analyzed at a later date/time by operators, experts, dealers, OEMs, and the like as described herein.

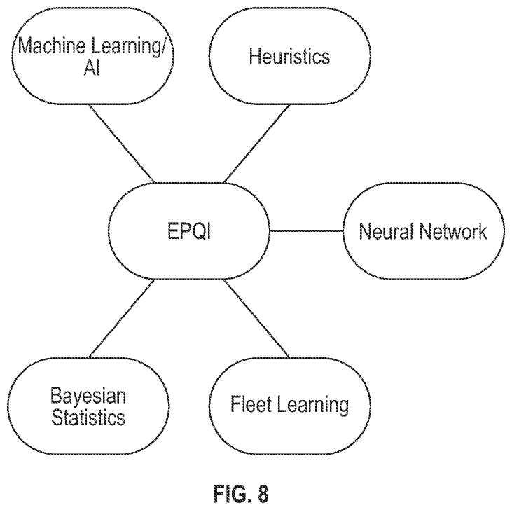

Still additional aspects of the disclosure are shown in FIG. 8. As has been noted, the EPQI is determined from a number of inputs. This determination will continue to improve over time and may include different ways to review the continuous data for improvement. Some, but not all, of the ways the system 300 can be improved over time are shown in FIG. 8. Each of the learning methodologies/techniques/networks/models shown in FIG. 8 can be used by aspects of embodiments of the present disclosure. For example, each of the learning methodologies/techniques/networks/models shown in FIG. 8 could be used to optimize and/or improve aspects of embodiments of the present disclosure. While the learning methodologies/techniques/networks/models of FIG. 8 could be used by various aspects of various embodiments of the present disclosure, in particular, the system 300 could use any and/or all of the learning methodologies/techniques/networks/models depicted in FIG. 8, as well as any other learning methodologies/techniques/networks/models, to optimize and/or improve determination, calculation, and/or improvement of an expected planting quality index. For instance, any and/or all of the learning methodologies/techniques/networks/models of FIG. 8 could be applied to review a plurality of data types, such as those of FIG. 5, and identify one or more classifiers in the form of an expected planting quality indicator that corresponds to an operational quality of planting based upon the plurality of data types. In order to identify one or more classifiers in the form of an expected planting quality indicator and to optimize and/or improve aspects of embodiments of the present disclosure, any and/or all of the methodologies/techniques/networks/models can use training data according to some embodiments.

It is envisioned that the system 300, such as via the processor 305, could include the use of heuristics in order to continuously improve and learn. A heuristic technique is an approach to problem solving or self-discovery using ‘a calculated guess’ derived from previous experiences. A heuristic is normally a hand-coded function. The use or incorporation of heuristics in the system 300, such as in the offseason by the OEM, will continuously improve determination and/or calculation of the EPQI and provide better suggestions for improvement of the same during use of the implement.

The system/processor 300/305 could also employ artificial intelligence (Al) such as via machine learning and/or a neural network. Al is intelligence embodied by machines, such as computers and/or processors. While Al has many definitions, some have defined Al as utilizing machines and/or systems to mimic human cognitive ability such as decision-making and/or problem solving. Al has additionally been described as machines and/or systems that are capable of acting rationally such that they can discern their environment and efficiently and effectively take the necessary steps to maximize the opportunity to achieve a desired outcome. Goals of Al can include but are not limited to reasoning, problem-solving, knowledge representation, planning, learning, natural language processing, perception, motion and manipulation, social intelligence, and general intelligence. Al tools used to achieve these goals can include but are not limited to searching and optimization, logic, probabilistic methods, classification, statistical learning methods, artificial neural networks, machine learning, and deep learning.

Machine learning (ML) is the study of computer algorithms that can improve automatically through experience and by the use of data. ML is seen as a part of Al. Machine learning algorithms build a model based on sample data, known as “training data”, in order to make predictions or decisions without being explicitly programmed to do so. A machine learning algorithm and/or model can be developed such that it can be trained using training data to ultimately make predictions and/or decisions. Machine learning can include different approaches such as supervised learning, unsupervised learning, semi-supervised learning, reinforcement learning, and dimensionality reduction as well as other types. Supervised learning models are trained using training data that includes inputs and the desired output. This type of training data can be referred to as labeled data wherein the output provides a label for the input. The supervised learning model will be able to develop, through optimization or other techniques, a method and/or function that is used to predict the outcome of new inputs. Unsupervised learning models take in data that only includes inputs and engage in finding commonalities in the inputs such as grouping or clustering of aspects of the inputs. Thus, the training data for unsupervised learning does not include labeling and/or classification. Unsupervised learning models can make decisions for new data based on how alike or similar it is to existing data and/or to a desired goal. Examples of machine learning models include but are not limited to artificial neural networks, decision trees, support-vector machines, regression analysis, Bayesian networks, and genetic algorithms. Examples of potential applications of machine learning include but are not limited to image segmentation and classification, ranking, recommendation systems, visual identity tracking, face verification, and speaker verification.

For the present disclosure, the machine learning could be used to identify classifiers, such as input settings of the implement, ambient conditions, parts, status of components (age, wear/tear, version, etc.), and the like to train the system 300 to identify and learn the best solutions/combinations based upon the inputs in order to provide the highest possible EPQI. The ML could be incorporated into the processor 305, incorporated into cloud processors, performed at a remote location, or even performed at the OEM/dealer in order to continuously learn and update to provide the best information for the system 300.

Another way the system 300 could improve is by the use of Bayesian statistics and/or Bayesian networks, which uses the probability of an event occurring to provide the needed information and feedback. This could be implemented and set up to evaluate the inputs, including any settings, ambient conditions, feedback from components, statuses, types of inputs, etc., in order to provide an EPQI based upon the probability of the ability of the machine/component/planting implement to operate.

In addition, fleet learning could be incorporated with the system 300 to improve operation and understanding of EPQI for all connected implements to the system 300, such as all that are connected to a processor/display of the system 300, regardless of ownership. In fleet learning, a system, such as the processor calculating the EPQI, for one implement learns something based on new information, such as a setting or the like. If it is valuable as a whole, this will be pushed out to all devices that may use the EPQI function, which provides benefits to all implements, and not just the singular implement. This is beneficial for all, and may be provided at the OEM level, such as when evaluating and updating the system 300 in the offseason.

Therefore, it has been shown that the use of EPQI provides numerous improvements and/or advantages for operation of one or more implements, such as planting implements. The feedback provided can be useful for operators, dealers, and OEMs in order to improve products and provide the best scenario for operation of the implements. The information that is tracked to determine the expected planting quality can be used by the operator, shared with experts, or shared with planter dealers and OEMs to help with diagnosing issues, making purchasing decisions, making decisions about best planting practices, and by the OEMs to make a better product. It should be appreciated that any number of variations, alternatives, or the like, which are obvious to those skilled, is intended to be a part of the present disclosure.

1. A method for estimating an expected planting quality indicator, comprising:
receiving, via a processor, a plurality of types of data associated with planting via an agricultural planting implement;
combining, via the processor, the plurality of types of data to calculate an expected planting quality indicator;
wherein the expected planting quality indicator is calculated by:
determining an optimal planting quality indicator; and
comparing the optimal planting quality value to the collected plurality of types of data associated with planting via the agricultural planting implement.

2. The method of claim 1, further comprising updating a setting of the agricultural planting implement based on the expected planting quality indicator.

3. The method of claim 2, wherein the setting is updated automatically via the processor.

4. The method of claim 1, further comprising displaying the expected planting quality indicator on a display.

5. The method of claim 4, further comprising displaying a suggested change to one or more settings of the agricultural planting implement to improve the expected planting quality indicator.

6. The method of claim 1, further comprising storing the expected planting quality indicator and the plurality of types of data to a memory.

7. The method of claim 6, further comprising analyzing a plurality of expected planting quality indicators based upon the plurality of types of data to improve the agricultural planting implement.

8. The method of claim 1, wherein at least one of the plurality of types of data comprises ambient weather conditions.

9. The method of claim 1, wherein at least one of the plurality of types of data comprises GPS data.

10. A system for estimating an expected planting quality value, comprising:
a processor;
a memory and/or a non-transitory computer readable medium that stores executable instructions that, when executed by the processor, perform operations, the operations comprising:
collecting, via the processor, a plurality of types of data associated with planting via an agricultural planting implement;
combining, via the processor, the plurality of types of data to calculate an expected planting quality value;
wherein the expected planting quality value is calculated by:
determining an optimal planting quality value; and
comparing the optimal planting quality value to the collected plurality of types of data associated with planting via the agricultural planting implement.

11. The system of claim 10, wherein the processor is part of a display.

12. The system of claim 11, wherein the display is configured to display the expected planting quality value.

13. The system of claim 12, wherein the display comprises a graphical user interface.

14. The system of claim 13, wherein a user can make a change to one or more settings of the agricultural planting implement, via the graphical user interface, based upon the expected planting quality value.

15. The system of claim 13, wherein the graphical user interface comprises a map, and wherein the expected planting quality value is shown relative to a location on the map.

16. The system of claim 15, wherein the collected plurality of types of data and the expected planting quality value are saved in the memory and/or the non-transitory computer readable medium as a data pair comprising a location and the expected planting quality value.

17. A system for estimating an expected planting quality value of an agricultural planting implement, the system comprising:
at least one processor and at least one memory configured to implement a learning model, the learning model generated from training data, wherein the learning model is trained with a method comprising the steps of:
reviewing a plurality of data types associated with planting via the agricultural planting implement; and
identifying a classifier in the form of an expected planting quality value that corresponds to an operational quality of planting based upon the plurality of data types; and
wherein the learning model is stored on one or more non-transitory computer readable media comprising instructions comprising:
collecting, in real time, data associated with planting via the agricultural planting implement; and
generating and displaying the expected planting quality value for the collected data via a display.

18. The system of claim 17, wherein the expected planting quality value is stored on the at least one memory and/or the one or more non-transitory computer readable media.

19. The system of claim 17, wherein the instructions of the one or more non-transitory computer readable media further comprise generating and displaying, via the display, suggestions for improving the expected planting quality value.

20. The system of claim 17, wherein the plurality of data types comprises GPS data, ambient weather conditions, and settings of the agricultural planting implement.
